(19) United States
(12) Patent Application Publication
(10) Pub. No.: US 2025/0287392 A1
(43) Pub. Date: Sep. 11, 2025

(54) SHARED RADIO DYNAMIC RADIO RESOURCE HANDLING

(71) Applicant: Telefonaktiebolaget LM Ericsson (publ), Stockholm (SE)

(72) Inventors: Fredrik WOXBERG, Västra Frölunda (SE); Mikael KJELLBERG, Mölndal (SE); Jacob ÖSTERLING, Järfälla (SE)

(21) Appl. No.: 18/858,838

(22) PCT Filed: Apr. 29, 2022
(86) PCT No.: PCT/EP2022/061620

§ 371 Date: Oct. 22, 2024

(51) Int. Cl. H04W 72/231; H04W 28/02; H04W 88/08

(52) U.S. Cl. CPC H04W 72/231; H04W 28/0236; H04W 28/0268; H04W 88/085

(57) ABSTRACT

A method, system and apparatus are disclosed. A radio resource handler, RRH, configured to communicate at least with a plurality of baseband units and a first shared radio unit that is shared by the plurality of baseband units is provided. The RRH receives a first resource indication associated with the first shared radio unit indicating a plurality of dedicated resources and a plurality of shared resources. The RRH determines a first resource grant based at least on the first resource indication indicating at least one of: at least a first resource from the plurality of dedicated resources to allocate to a first baseband unit of the plurality of baseband units, and at least a second resource from the plurality of shared resources to allocate to the first baseband unit. The RRH transmits the first resource grant to the first baseband unit.

### FIELD

The present disclosure relates to wireless communications, and in particular, to shared radio resource handling.

### BACKGROUND

In existing systems, Communication Service Provider (CSP) Radio Networks may be built using BaseBand units (BBs) handling end-user devices (UEs) and managing (e.g., scheduling) air interface (e.g., cell) resources. BBs may be connected, e.g., over a fronthaul infrastructure, to relatively less complex radio/antenna units transmitting and receiving signals on radio frequency (RF) cell-carriers to/from end-users.

CSPs may use a combination of several spectrum assets, e.g., to deliver peak rates to end-users by aggregating multiple spectrum assets, and radio units may also support multiple bands and/or multiple carriers within a band.

Radios/radio units are increasingly requiring greater signal processing capability, e.g., for beam-forming, multiple-input and multiple-output (MIMO), etc. At the same time, fronthaul infrastructure is evolving from synchronous, circuit switched, point-to-point connections (e.g., time-domain samples using Common Public Radio Interface (CPRI) transport), towards asynchronous packet-based network topologies (e.g., frequency-domain information data with the introduction of enhanced Common Public Radio Interface (eCPRI)).

As a result of the above, processing requirements for radio units are continuously increasing, as illustrated in FIG. 1.

In existing systems, there may be a need to share radio and/or antenna equipment between several users (CSPs), e.g., to reduce installation footprint and/or cost, e.g., total cost of ownership (TCO). For example, spectrum is an important asset for CSPs to maintain radio access network (RAN) level competition, but sharing spectrum may be prohibited by regulators and/or not be desired by competing CSPs. As a consequence, radio solutions where each CSP uses its own spectrum (e.g., Multi-Operator Radio Access Network (MORAN)), may be preferred as a sharing technique. Current sharing solutions (e.g., Open Radio Access Network (ORAN)) may be dimensioned to satisfy user spectrum and performance independently of each other, e.g., by applying simple static allocations of dedicated radio resources per CSP.

With increased spectrum, responsibility for signal processing, and serving multiple users, the requirements on radio processing grows additionally, as illustrated in FIG. 2.

In existing systems, actual utilization of resources per user may often be very low, as illustrated in FIG. 3. For example, scenarios where multiple users simultaneously require their maximum allocated capacity may be very limited, and allocating resources this way may result in inefficient use of radio equipment and spectrum, while also increasing installation cost and complexity significantly.

Another existing technique is to have different radio users (e.g., BBs) negotiate between each other and in every time period send resource need requests to their counterparts. For example, in some existing solutions, BBs optimally share the output power ability of a power amplifier between GSM, LTE and WCDMA. Drawbacks of such solutions, however, include:

Run-time complexity—The run-time complexity (e.g., error cases) and cycle consumption may grow exponentially with number of users connected.

No mediation is introduced in the signaling-Upgrading of protocols and feature sets must be coordinated on both sides. This may limit the ability to mix different vendors of radio user (e.g., BBs), and may also limit multiple operators using different versions of software, hardware, protocols, etc.

Locality—Existing solutions may only work on radios shared between two users. The radio resource handler (RRH) may need to coordinate the use of multiple radios, some of which may not be known/used by all radio users (e.g., BBs).

Integrity of the radio capability—Existing solutions may require that schedulers of each radio user (e.g., BB) understands the restrictions of the radio. The RRH can abstract this and forward only rules relevant for the Radio User (BB). The RRH can be supplied by the vendor of the radio itself, hiding/abstracting the actual radio limitations.

### SUMMARY

Some embodiments advantageously provide methods, systems, and apparatuses for shared radio dynamic radio resource handling.

According to one aspect of the present disclosure, a radio resource handler, RRH, configured to communicate at least with a plurality of baseband units and a first shared radio unit that is shared by the plurality of baseband units is provided. The RRH comprises processing circuitry configured to receive a first resource indication associated with the first shared radio unit, the first resource indication indicating a plurality of dedicated resources and a plurality of shared resources. The processing circuitry is further configured to determine a first resource grant based at least on the first resource indication, the first resource grant indicating at least one of: at least a first resource from the plurality of dedicated resources to allocate to a first baseband unit of the plurality of baseband units; and at least a second resource from the plurality of shared resources to allocate to the first baseband unit. The processing circuitry is further configured to cause transmission of the first resource grant to the first baseband unit.

According to another aspect of the present disclosure, a method implemented in a radio resource handler, RRH, configured to communicate at least with a plurality of baseband units and a first shared radio unit that is shared by the plurality of baseband units, is provided. A first resource indication associated with the first shared radio unit is received, where the first resource indication indicates a plurality of dedicated resources and a plurality of shared resources. A first resource grant is determined based at least on the first resource indication, where the first resource grant indicates at least one of: at least a first resource from the plurality of dedicated resources to allocate to a first baseband unit of the plurality of baseband units; and at least a second resource from the plurality of shared resources to allocate to the first baseband unit. The first resource grant is transmitted to the first baseband unit.

According to another aspect of the present disclosure, a shared radio unit configured to communicate at least with a radio resource handler, RRH, a plurality of baseband units, and a plurality of wireless devices, where the shared radio unit is shared by the plurality of baseband units, is provided. The shared radio unit comprising processing circuitry configured to receive a resource selection associated with a first baseband unit of the plurality of baseband units, where the resource selection indicates at least one of: at least one first resource from a plurality of dedicated resources, the at least one first resource being allocated to the first baseband unit; and at least one second resource from a plurality of shared resources, the at least one second resource being allocated to the first baseband unit. The processing circuitry is further configured to determine, based on the resource selection, at least one resource for transmission.

According to another aspect of the present disclosure, a method implemented in a shared radio unit configured to communicate at least with a radio resource handler, RRH, a plurality of baseband units, and a plurality of wireless devices, the shared radio unit being shared by the plurality of baseband units, is provided. A resource selection associated with a first baseband unit of the plurality of baseband units is received, where the resource selection indicates at least one of: at least one first resource from a plurality of dedicated resources, the at least one first resource being allocated to the first baseband unit; and at least one second resource from a plurality of shared resources, the at least one second resource being allocated to the first baseband unit. Based on the resource selection, at least one resource for transmission is determined.

According to another aspect of the present disclosure, a baseband unit in communication with at least a radio resource handler, RRH, and a shared radio unit, the baseband unit being associated with a plurality of wireless devices, is provided. The baseband unit comprises processing circuitry configured to receive, from the RRH, a resource grant indicating at least one of: at least one first resource from a plurality of dedicated resources, the at least one first resource being allocated to the baseband unit; and at least one second resource from a plurality of shared resources, the at least one second resource being allocated to the baseband unit. The processing circuitry is further configured to determine, based on the resource grant, at least one resource for transmission. The processing circuitry is further configured to cause transmission of a resource selection to the shared radio unit indicating the at least one determined resource for transmission.

According to another aspect of the present disclosure, a method implemented in a baseband unit in communication with at least a radio resource handler, RRH, and a shared radio unit, where the baseband unit is associated with a plurality of wireless devices, is provided. A resource grant is received from the RRH indicating at least one of: at least one first resource from a plurality of dedicated resources, the at least one first resource being allocated to the baseband unit; and at least one second resource from a plurality of shared resources, the at least one second resource being allocated to the baseband unit. Based on the resource grant, at least one resource for transmission is determined. A resource selection is transmitted to the shared radio unit indicating the at least one determined resource for transmission.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an example network architecture and resource allocation scenario;

FIG. 2 is a diagram of another example network architecture and resource allocation scenario;

FIG. 3 is a graph depicting radio processing needs over time in an example resource allocation scenario;

FIG. 4 is a schematic diagram of an example network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a block diagram of a baseband unit according to some embodiments of the present disclosure;

FIG. 7 is a block diagram of a radio resource handler according to some embodiments of the present disclosure;

FIG. 8 is a flowchart illustrating example methods implemented in a communication system including a host computer, a network node and a wireless device for executing a client application at a wireless device according to some embodiments of the present disclosure;

FIG. 9 is a flowchart illustrating example methods implemented in a communication system including a host computer, a network node and a wireless device for receiving user data at a wireless device according to some embodiments of the present disclosure;

FIG. 10 is a flowchart illustrating example methods implemented in a communication system including a host computer, a network node and a wireless device for receiving user data from the wireless device at a host computer according to some embodiments of the present disclosure;

FIG. 11 is a flowchart illustrating example methods implemented in a communication system including a host computer, a network node and a wireless device for receiving user data at a host computer according to some embodiments of the present disclosure;

FIG. 12 is a flowchart of an example process in a radio resource handler for allocating resources in a network according to some embodiments of the present disclosure;

FIG. 13 is a flowchart of an example process in a shared radio unit (network node) for determining resources for transmission according to some embodiments of the present disclosure;

FIG. 14 is a flowchart of an example process in a baseband unit for selecting resources for transmission according to some embodiments of the present disclosure;

FIG. 15 is a diagram of an example network architecture and resource allocation scenario according to some embodiments of the present disclosure;

FIG. 16 diagram of another example network architecture and resource allocation scenario according to some embodiments of the present disclosure;

FIG. 17 is a diagram of an example network architecture and resource allocation scenario according to some embodiments of the present disclosure;

FIG. 18 is a diagram of an example resource allocation scenario according to some embodiments of the present disclosure;

FIG. 19 is a diagram of another example resource allocation scenario according to some embodiments of the present disclosure;

FIG. 20 is a diagram depicting radio resources according to some embodiments of the present disclosure;

FIG. 21 is a diagram depicting radio resource performance according to some embodiments of the present disclosure;

FIG. 22 is a diagram of another example resource allocation scenario according to some embodiments of the present disclosure;

FIG. 23 is a diagram of another example resource allocation scenario according to some embodiments of the present disclosure;

FIG. 24 is a diagram of another example resource allocation scenario according to some embodiments of the present disclosure;

FIG. 25 is a diagram of another example resource allocation scenario according to some embodiments of the present disclosure;

FIG. 26 is a diagram of another example resource allocation scenario according to some embodiments of the present disclosure;

FIG. 27 is a signaling diagram depicting a resource allocation scenario according to some embodiments of the present disclosure; and

FIG. 28A is a diagram of an example network architecture according to some embodiments of the present disclosure;

FIG. 28B is a diagram of another example network architecture according to some embodiments of the present disclosure; and

FIG. 28C is a diagram of another example network architecture according to some embodiments of the present disclosure.

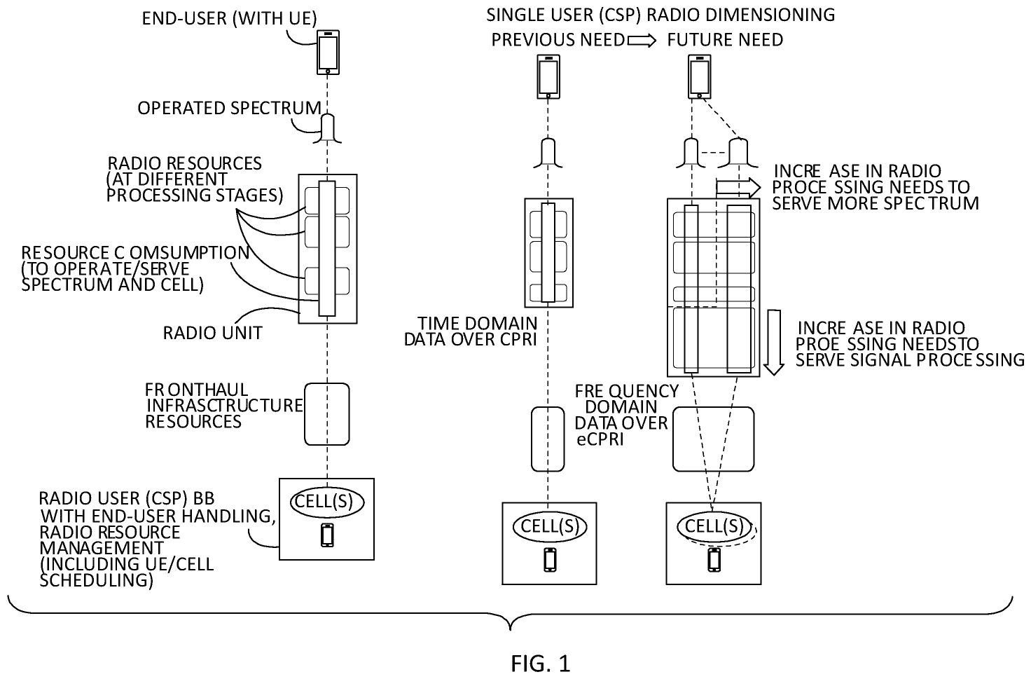

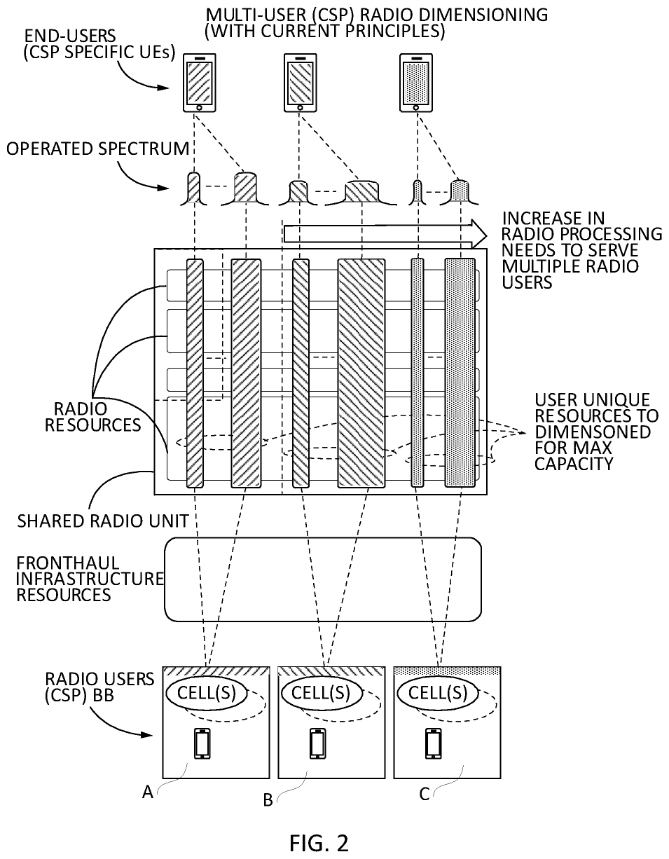

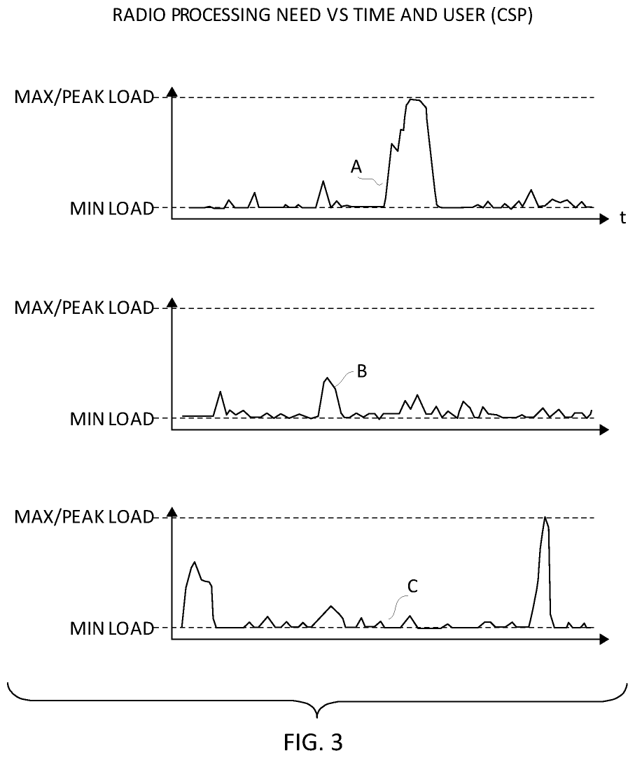

### DETAILED DESCRIPTION

Before describing in detail example embodiments, it is noted that the embodiments reside primarily in combinations of apparatus components and processing steps related to shared radio dynamic radio resource handling. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments described herein, “full performance” (as in “served with full performance”) may refer to one or more performance metrics/thresholds being satisfied (e.g., a data throughput metric, an error rate, a latency metric, etc.), where such performance metrics may be predefined and/or may be explicitly/implicitly indicated by one or more network entities, and which may be based on policies, radio conditions, capabilities, etc.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head, a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), a shared radio unit, a radio resource handler, a shared radio manager, a baseband unit (BB), a baseband resource handler (BB RH), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (CNB), Node B, gNB, Multi-cell/multicast Coordination Entity (MCE), IAB node, relay node, access point, radio access point, Remote Radio Unit (RRU) Remote Radio Head, shared radio unit, a radio resource handler, a shared radio manager, a baseband unit (BB), a baseband resource handler (BB RH), etc.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

The term “dropping indication” as used herein can be any indication, message, notification, communication, signal, etc., which is associated with (i.e., indicative of) a failure to execute a process, such as a radio reception or transmission failure/fault/error/etc., a failure to meet a performance level, etc.

The term “performance indication” as used herein can be any indication, message, notification, communication, signal, etc., which is associated with (i.e., indicative of) a performance level, such as a requested performance level, a measured performance level, a predicted performance level, etc., and may include, for example, one or more radio transmission/reception resources, antenna resources, data speed/throughput, (signal) processing speed/throughput, power resources/utilization, bandwidth (frequency-domain) resources/utilization, time-domain resources/utilization, etc.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide shared radio dynamic radio resource handling.

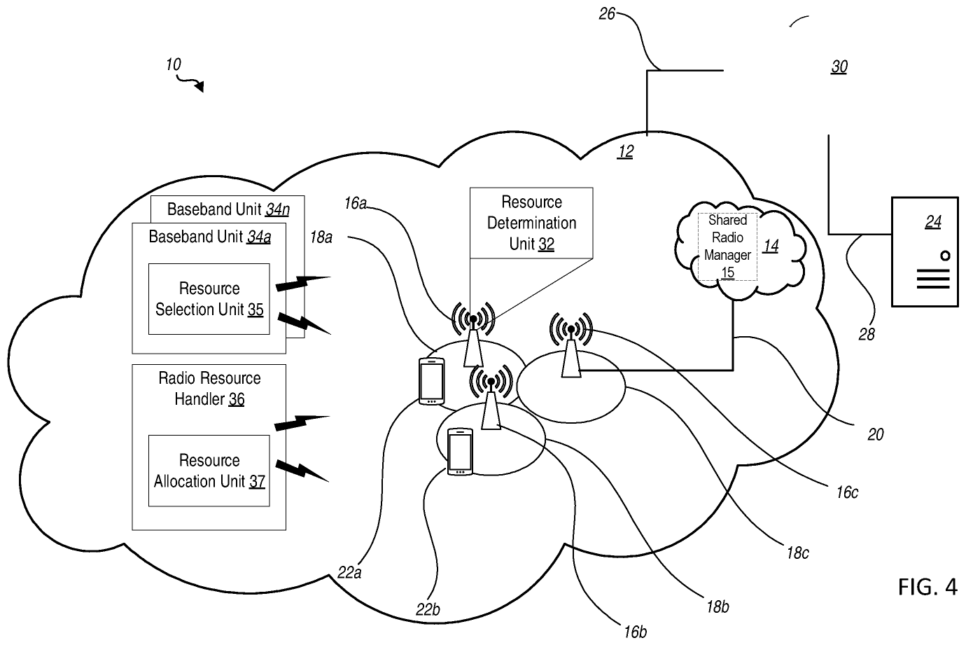

Referring now to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The core network may include a shared radio manager (SRM) 15, as described herein. The access network 12 comprises a plurality of network nodes 16a, 16b, 16c (referred to collectively as network nodes 16), such as NBs, eNBs, gNBs, shared radio units, radio resource handlers, shared radio managers, baseband units (BBs), baseband resource handlers (BB RHs), or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16, such a shared radio unit 16, is configured to include a resource determination unit 32 which is configured to determine, based on a resource selection, at least one resource for transmission, as described herein.

The access network 12 may also include one or more baseband units (BB) 34a-n (collectively, baseband units 34), one or more of which may be configured to include a resource selection unit 35 which is configured to perform one or more BB 34 functions as described herein such as selecting/determining, based on a resource grant, at least one resource for transmission, as described herein.

The access network 12 may also include a radio resource handler (RRH) 36, which may be configured to include a resource allocation unit 37 which is configured to perform one or more RRH 36 functions as described herein such as allocating/determining a resource grant, e.g., for a baseband unit 34, as described herein.

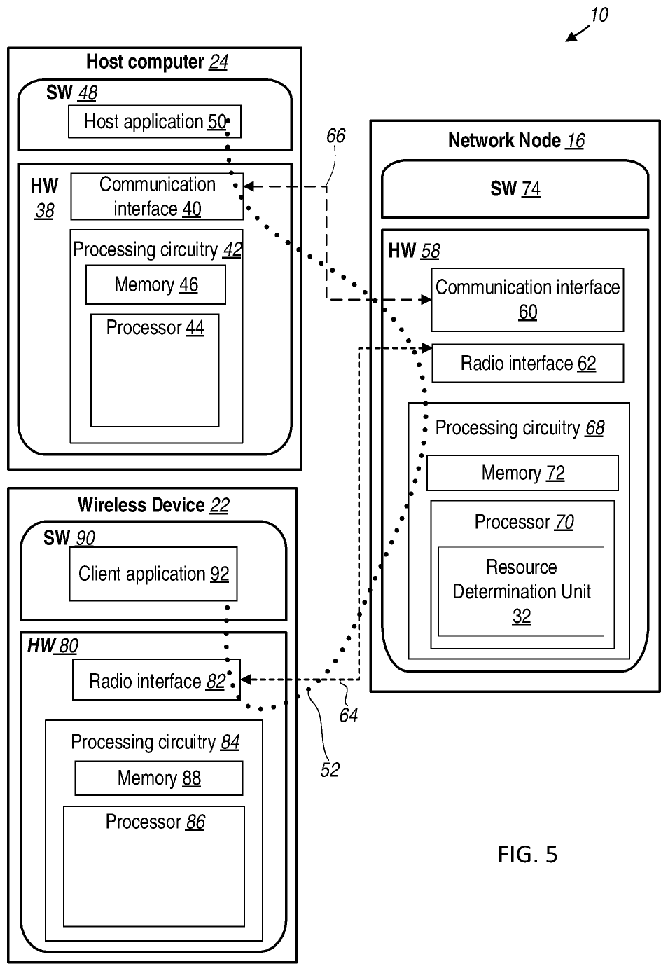

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16, the wireless device 22, the BB 34, and/or the RRH 36.

The communication system 10 further includes a network node 16 (e.g., a shared radio unit) provided in a communication system 10 and including hardware 58 enabling it to communicate with the host computer 24, the WD 22, the BB 34, and the RRH 36. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include resource determination unit 32 configured to determine, based on a resource selection, at least one resource for transmission.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

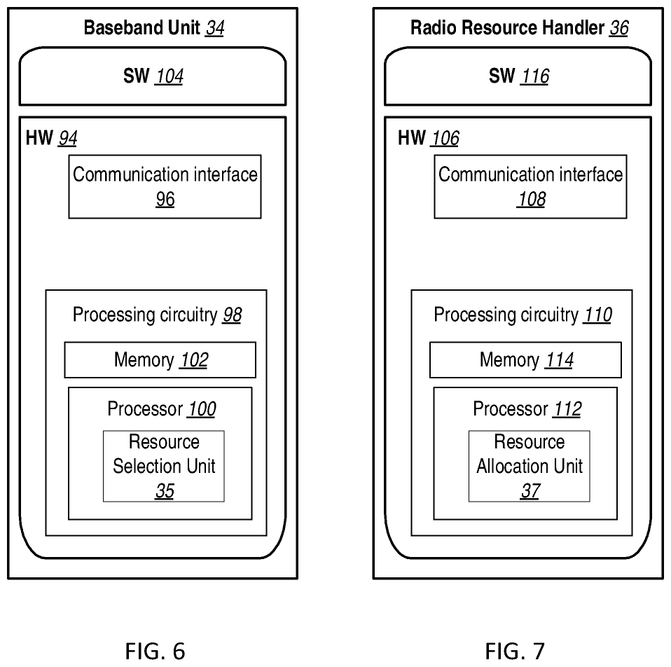

Example implementations, in accordance with an embodiment, of the BB 34 discussed in the preceding paragraphs will now be described with reference to FIG. 6. The communication system 10 further includes a BB 34 provided in a communication system 10 and including hardware 94 enabling it to communicate with the host computer 24, the WD 22, the network node 16 (e.g., the shared radio unit), and the RRH 36. The hardware 94 may include a communication interface 96 for setting up and maintaining a wired or wireless connection with an interface of a different communication device of the communication system 10. The communication interface 96 may be configured to facilitate a connection to the wireless device 22, the host computer 24, and the RRH 36. The connection may be direct or it may pass through a core network 14 of the communication system 10 and/or through one or more intermediate networks 30 outside the communication system 10.

In the embodiment shown, the hardware 94 of the BB 34 further includes processing circuitry 98. The processing circuitry 98 may include a processor 100 and a memory 102. In particular, in addition to or instead of a processor, such as a central processing unit, and memory, the processing circuitry 98 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 100 may be configured to access (e.g., write to and/or read from) the memory 102, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the BB 34 further has software 104 stored internally in, for example, memory 102, or stored in external memory (e.g., database, storage array, network storage device, etc.) accessible by the BB 34 via an external connection. The software 104 may be executable by the processing circuitry 98. The processing circuitry 98 may be configured to control any of the methods and/or processes described herein and/or to cause such methods, and/or processes to be performed, e.g., by BB 34. Processor 100 corresponds to one or more processors 100 for performing BB 34 functions described herein. The memory 102 is configured to store data, programmatic software code and/or other information described herein. In some embodiments, the software 104 may include instructions that, when executed by the processor 100 and/or processing circuitry 98, causes the processor 100 and/or processing circuitry 98 to perform the processes described herein with respect to BB 34. For example, processing circuitry 98 of the BB 34 may include resource selection unit 35 configured to select/determine a resource for transmission based on a resource grant.

Example implementations, in accordance with an embodiment, of the RRH 36 discussed in the preceding paragraphs will now be described with reference to FIG. 7. The communication system 10 further includes a RRH 36 provided in a communication system 10 and including hardware 106 enabling it to communicate with the host computer 24, the WD 22, the network node 16 (e.g., the shared radio unit), and the BB 34. The hardware 106 may include a communication interface 108 for setting up and maintaining a wired or wireless connection with an interface of a different communication device of the communication system 10. The communication interface 108 may be configured to facilitate a connection to the wireless device 22, the host computer 24, and the BB 34. The connection may be direct or it may pass through a core network 14 of the communication system 10 and/or through one or more intermediate networks 30 outside the communication system 10.

In the embodiment shown, the hardware 106 of the RRH 36 further includes processing circuitry 110. The processing circuitry 110 may include a processor 112 and a memory 114. In particular, in addition to or instead of a processor, such as a central processing unit, and memory, the processing circuitry 110 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 112 may be configured to access (e.g., write to and/or read from) the memory 114, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the RRH 36 further has software 116 stored internally in, for example, memory 114, or stored in external memory (e.g., database, storage array, network storage device, etc.) accessible by the RRH 36 via an external connection. The software 116 may be executable by the processing circuitry 110. The processing circuitry 110 may be configured to control any of the methods and/or processes described herein and/or to cause such methods, and/or processes to be performed, e.g., by RRH 36. Processor 112 corresponds to one or more processors 112 for performing RRH 36 functions described herein. The memory 114 is configured to store data, programmatic software code and/or other information described herein. In some embodiments, the software 116 may include instructions that, when executed by the processor 112 and/or processing circuitry 110, causes the processor 112 and/or processing circuitry 110 to perform the processes described herein with respect to RRH 36. For example, processing circuitry 110 of the RRH 36 may include resource allocation unit 37 configured to determine/allocate resources for transmission among one or more BBs 34 and one or more shared radio units (e.g., network nodes 16).

In some embodiments, the inner workings of the network node 16, WD 22, host computer 24, BB 34, and RRH 36 may be as shown in FIGS. 5, 6, and 7, and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4, 5, 6, and 7 show various “units” such as resource determination unit 32, resource selection unit 35, and resource allocation unit 37 as being within a respective processor, it is contemplated that these units may be implemented such that a portion of the unit is stored in a corresponding memory within the processing circuitry. In other words, the units may be implemented in hardware or in a combination of hardware and software within the processing circuitry. Further, although the BB 34 and RRH 36 are depicted as separate from the network node 16, it is contemplated that the BB 34 and/or RRH 36 may be co-located with/within the network node 16 and/or may be physically and/or logically separate.

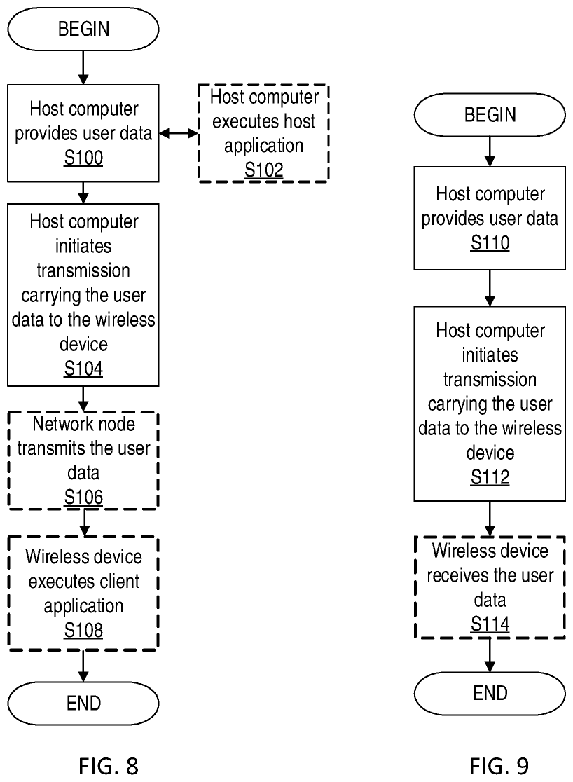

FIG. 8 is a flowchart illustrating an example method implemented in a communication system, such as, for example, the communication system of FIGS. 4, 5, 6, and 7, in accordance with one embodiment. The communication system may include a host computer 24, a network node 16, a WD 22, a BB 34, and a RRH 36, which may be those described with reference to FIGS. 4, 5, 6, and 7. In a first step of the method, the host computer 24 provides user data (Block S100). In an optional substep of the first step, the host computer 24 provides the user data by executing a host application. such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an example method implemented in a communication system, such as, for example, the communication system of FIGS. 4, 5, 6, and 7, in accordance with one embodiment. The communication system may include a host computer 24, a network node 16, a WD 22, a BB3 34, and a RRH 36, which may be those described with reference to FIGS. 4, 5, 6, and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

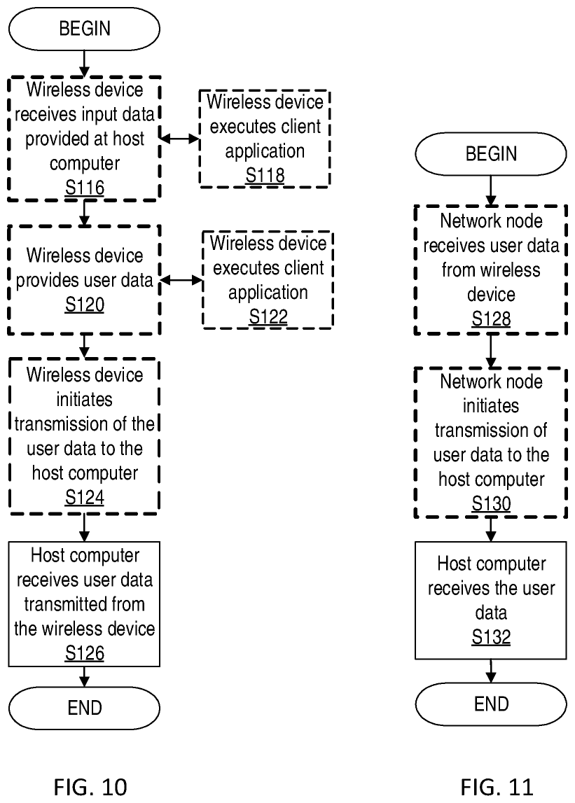

FIG. 10 is a flowchart illustrating an example method implemented in a communication system, such as, for example, the communication system of FIGS. 4, 5, 6, and 7, in accordance with one embodiment. The communication system may include a host computer 24, a network node 16, a WD 22, a BB 34, and a RRH 36, which may be those described with reference to FIGS. 4, 5, 6, and 7. In an optional first step of the method, the WD 22 receives input data provided by the host computer 24 (Block S116). In an optional substep of the first step, the WD 22 executes the client application 92. which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an example method implemented in a communication system, such as, for example, the communication system of FIGS. 4, 5, 6, and 7, in accordance with one embodiment. The communication system may include a host computer 24, a network node 16, a WD 22, a BB 34, and a RRH 36, which may be those described with reference to FIGS. 4, 5, 6, and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

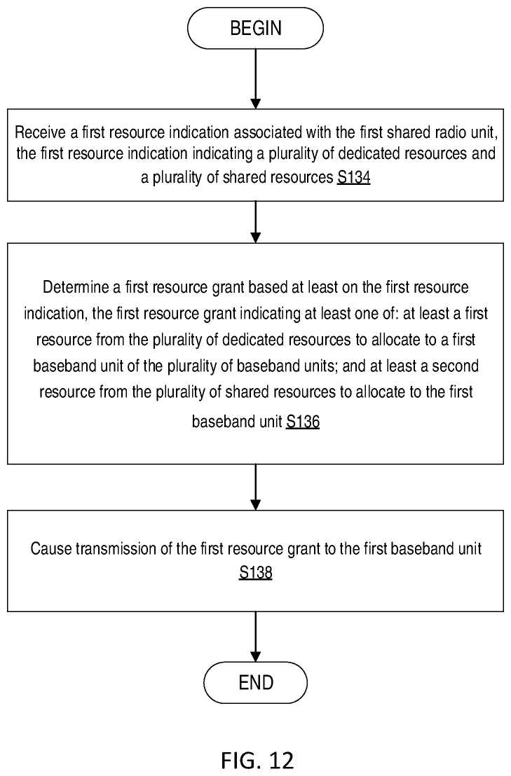

FIG. 12 is a flowchart of an example process in a RRH 36 according to some embodiments of the present disclosure. One or more Blocks described herein may be performed by one or more elements of RRH 36 such as by one or more of processing circuitry 110 (including the resource allocation unit 37), processor 112, and/or communication interface 108, etc., according to the example method. The method includes receiving (Block S134), such as via RRH 36, a first resource indication associated with the first shared radio unit, the first resource indication indicating a plurality of dedicated resources and a plurality of shared resources. The method includes determining (Block S136), such as via RRH 36, determine a first resource grant based at least on the first resource indication, the first resource grant indicating at least one of: at least a first resource from the plurality of dedicated resources to allocate to a first baseband unit 34 of the plurality of baseband units 34; and at least a second resource from the plurality of shared resources to allocate to the first baseband unit. The method includes transmitting (Block S138), such as via RRH 36, the first resource grant to the first baseband unit.

In one or more embodiments, the method further includes receiving a first status indication associated with the first shared radio unit, and the determining of the first resource grant is further based on the received first status indication. In one or more embodiments, the first status indication indicates at least one of: a hardware capability of the first shared radio unit 16, a temperature state of the first shared radio unit 16, and an interference state of the first shared radio unit 16. In one or more embodiments, the method further comprises receiving a second status indication associated with the first shared radio unit 16, the receiving of the second status indication being subsequent to the receiving of the first status indication, the second status indication being associated with a change in at least one of: the hardware capability of the first shared radio unit 16; the temperature state of the first shared radio unit 16; and the interference state of the first shared radio unit 16.

In one or more embodiments, the method further comprises receiving a third status indication from the first baseband unit, where the third status indication is associated with an interference state of the first shared radio unit 16, and where the determining the first resource grant is further based on the third status indication. In one or more embodiments, the method further comprises receiving a first resource request from the first baseband unit, where the determining of the first resource grant is further based on the received first resource request. In one or more embodiments, the method further comprises receiving a second resource request from a second baseband unit of the plurality of baseband units, where the determining of the first resource grant is further based on the second resource request.

In one or more embodiments, the first resource request includes at least one of: an amount of data to be transmitted, a quality of service class indication, a radio link quality indication, a user priority indication, a power level indication, an antenna indication, a time-domain resource indication, and a frequency-domain resource indication. In one or more embodiments, the first resource request indicates at least one of: a current traffic requirement associated with a plurality of wireless devices in communication with the first shared radio unit 16, a predicted traffic requirement associated with a plurality of wireless devices in communication with the first shared radio unit 16, and a fixed resource requirement associated with a plurality of wireless devices in communication with the first shared radio unit 16.

In one or more embodiments, each of the plurality of dedicated resources is associated with a corresponding one of the plurality of baseband units. In one or more embodiments, determining the first resource grant is further based on historical usage data associated with at least one of the plurality of baseband units. In one or more embodiments, the first resource grant indicates at least one of: a frequency range for transmission, a time interval for transmission, and an until further notice indication.

In one or more embodiments, determining the first resource grant further includes overbooking at least one of: the first resource from the plurality of dedicated resources, and the second resource from the plurality of shared resources. In one or more embodiments, the method further includes receiving the first resource request from a shared radio manager. In one or more embodiments, the method further includes receiving a dropping indication from at least one of: the first shared radio unit 16, and the first baseband unit; causing transmission of a performance indication to the shared radio manager based on the dropping indication; and receiving, from the shared radio manager, an updated resource configuration based on the performance indication. The updated resource configuration indicates at least one of: an updated plurality of dedicated resources, and an updated plurality of shared resources.

In one or more embodiments, a resource of the pluralities of dedicated and shared resources is at least one of: a power resource; a time-domain resource; a frequency-domain resource; an antenna resource; and a signal processing resource In one or more embodiments, each baseband unit of the plurality of baseband units is associated with a respective communication service provider. In one or more embodiments, the method further comprises determining a second resource grant based at least on the first resource request, where the second resource grant indicates at least one of: at least a third resource from the plurality of dedicated resources to allocate to a second baseband unit of the plurality of baseband units; and at least a fourth resource from the plurality of shared resources to allocate to the second baseband unit. The method further comprises causing transmission of the second resource grant to the second baseband unit.

In one or more embodiments, determining the second resource grant is further based on an interference state associated with at least one of the first and second baseband units. In one or more embodiments, the pluralities of dedicated resources and shared resources are associated with a plurality of shared radio units 16. In one or more embodiments, the first resource grant includes a first time-domain resource associated with the first shared radio unit 16 and a second time-domain resource associated with a second shared radio unit 16, the first time-domain resource and the second-time domain resource overlapping in time. In one or more embodiments, the first resource grant includes a first frequency-domain resource associated with the first shared radio unit 16 and a second frequency-domain resource associated with a second shared radio unit 16, the first frequency-domain resource and the second-frequency domain resource overlapping in frequency.

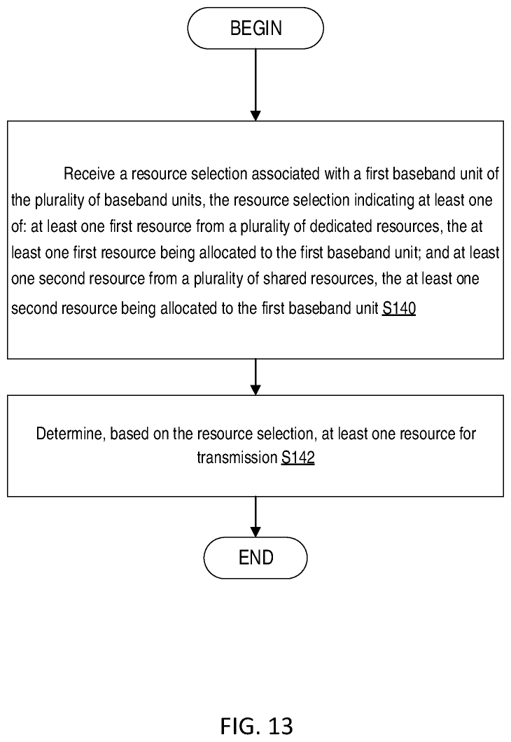

FIG. 13 is a flowchart of an example process in a shared radio unit 16 (e.g., a network node 16) according to some embodiments of the present disclosure. One or more blocks described herein may be performed by one or more elements of network node 16 such as by one or more of processing circuitry 68 (including the resource determination unit 32), processor 70, radio interface 62 and/or communication interface 60. The method includes receiving (Block S140), such as via network node 16, a resource selection associated with a first BB 34 of the plurality of BBs 34, the resource selection indicating at least one of: at least one first resource from a plurality of dedicated resources, the at least one first resource being allocated to the first BB 34; and at least one second resource from a plurality of shared resources, the at least one second resource being allocated to the first BB 34. The method includes determining (Block S142), such as via network node 16, at least one resource for transmission based on the resource selection.

In one or more embodiments, the method further comprises causing transmission of data to at least one wireless device using the determined at least one resource for transmission, and receiving data from at least one wireless device using the determined at least one resource for transmission. In one or more embodiments, determining the at least one resource for transmission includes dropping the at least one second resource from the resources for transmission based on a hardware requirement associated with the at least one second resource exceeding a hardware capability of the shared radio unit 16. In one or more embodiments, the method further comprises causing transmission of a dropping indication to the first baseband unit indicating the dropped at least one second resource.

In one or more embodiments, the method further comprises receiving a first resource indication from the RRH 36, the first resource indication indicating the plurality of dedicated resources and indicating, for each of the plurality of dedicated resources, a respective baseband unit of the plurality of baseband units, and dropping the at least one first resource from the resources for transmission based on the first resource indication indicating the at least one first resource being associated with a respective baseband unit other than the first baseband unit. In one or more embodiments, a resource of the pluralities of dedicated and shared resources is at least one of: a power resource; a time-domain resource; a frequency-domain resource; an antenna resource; and a signal processing resource. In one or more embodiments, each baseband unit of the plurality of baseband units is associated with a respective communication service provider.

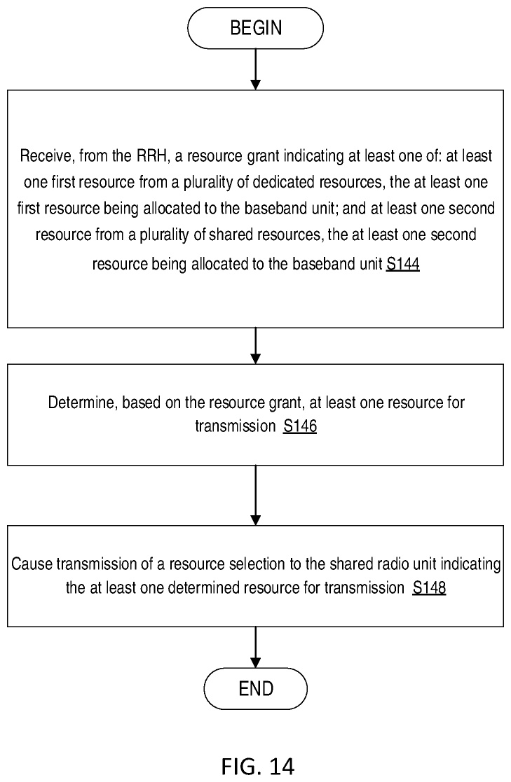

FIG. 14 is a flowchart of an example process in a BB 34 according to some embodiments of the present disclosure. One or more blocks described herein may be performed by one or more elements of BB 34 such as by one or more of processing circuitry 98 (including the resource selection unit 35), processor 100, and/or communication interface 96. The method includes receiving (Block S144), such as via BB 34, from the RRH 36, a resource grant indicating at least one of: at least one first resource from a plurality of dedicated resources, the at least one first resource being allocated to the baseband unit; and at least one second resource from a plurality of shared resources, the at least one second resource being allocated to the baseband unit. The method includes determining (Block S146), such as via BB 34, at least one resource for transmission based on the resource grant. The method includes transmitting (Block S148) a resource selection to the shared radio unit 16 (network node 16) indicating the at least one determined resource for transmission.

In one or more embodiments, the method further comprises transmitting a resource request to the RRH 36, the resource request being associated with the shared radio unit 16, the received resource grant being based on the transmitted resource request. In one or more embodiments, the resource request indicates at least one of an amount of data to be transmitted, a quality of service class indication, a radio link quality indication, a user priority indication, a power level indication, an antenna indication, a time-domain resource indication, and a frequency-domain resource indication.

In one or more embodiments, the resource request indicates at least one of: a current traffic requirement associated with the plurality of wireless devices 22, a predicted traffic requirement associated with the plurality of wireless devices 22, and a static traffic requirement associated with the plurality of wireless devices 22. In one or more embodiments, the received at least one resource grant is associated with a policy configuration.

In one or more embodiments, the method further comprises receiving, from the shared radio unit 16, a dropping indication indicating that at least one resource indicated by the resource selection was dropped, and at least one of: causing transmission of a modified resource request to the RRH based on the dropping indication; and causing transmission of a performance report to the RRH based on the dropping indication. In one or more embodiments, a resource of the pluralities of dedicated and shared resources is at least one of: a power resource; a time-domain resource; a frequency-domain resource; an antenna resource; and a signal processing resource. In one or more embodiments, the received at least one resource grant is associated with historical usage data associated with the plurality of wireless devices 22. In one or more embodiments, the baseband unit is associated with a respective communication service provider.

Having described the general process flow of arrangements of the disclosure and having provided examples of hardware and software arrangements for implementing the processes and functions of the disclosure, the sections below provide details and examples of arrangements for separating resources into dedicated (e.g., per radio user) guaranteed resources and shared resources, including techniques to vary the amount of dedicated/guaranteed resources and allocate shared resources between users dynamically. The resource allocation techniques described herein may allow more flexible and/or efficient radio dimensioning as compared to existing systems, enabling improved performance and capacity to all users while minimizing or eliminating the need for allocating dedicated parallel resources for each user.

One or more baseband unit 34 functions described below may be performed by one or more of processing circuitry 98, processor 100, resource selection unit 35, etc. One or more RRH 36 functions described below may be performed by one or more of processing circuitry 110, processor 112, resource allocation unit 37, etc. One or more network node 16 functions described below may be performed by one or more of processing circuitry 68, processor 70, resource determination unit 32, etc.

Radio resources that may be shared among users include capacities for one or more of: interface processing, signal processing, Fast Fourier Transforms (FFTs), cooling, output/input power, antennas, measurement resources (e.g., measurement receiver(s), corresponding signal processing resources, for example, for sensing a channel for listen-before-talk or other non-user-data-transmission measurement), etc.

Resources locked/guaranteed to certain users may include resources that may be needed to serve essential processing and performance and/or to keep one or more cells operational (e.g., used for primary cells and channels for synchronization, wireless device attach/move/control signaling, etc.), and/or may be based on policies (e.g., guaranteeing resources to a particular user based on the user's subscription/contract with the network operator).

In some embodiments, the allocation of shared processing resources of the radio to the client may be performed by the dynamic RRH 36, as described herein. Policies for resource sharing may be configured, e.g., using a Shared Radio Manager 15. The RRH 36 may notify users of the shared radio processing capabilities and/or usage constraints (e.g., to secure mandatory processing), and may monitor user needs and/or capabilities in real-time, e.g., to maximize utilization and performance (e.g., scheduling efficiency). Radio users (e.g., BBs 34) may also assist radio resource handling, e.g., by indicating/notifying the RRH 36 of their processing/resource needs in advance.

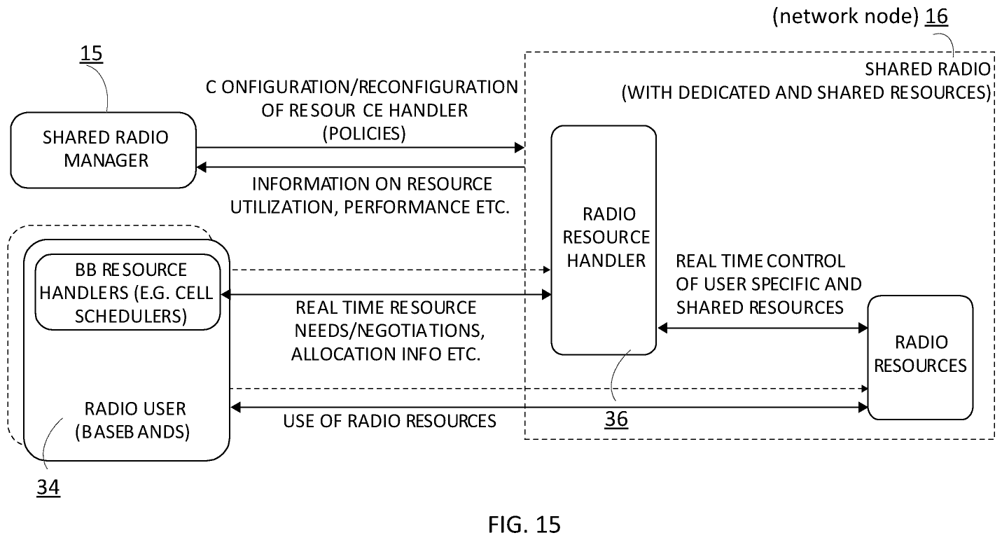

To help optimize system performance and aid in planning/optimization by locating areas where radio processing does not sufficiently meet needs, the RRH 36 may continuously and/or periodically report resource utilization, congestion, interference, etc., and may transmit such reports to the shared radio manager 15 and/or to the radio users (e.g., BBs 34), as shown in the example configuration of FIG. 15.

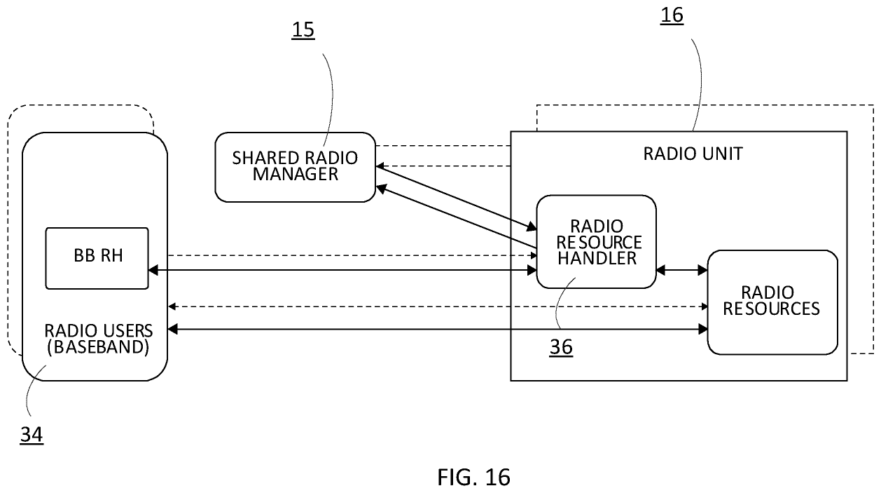

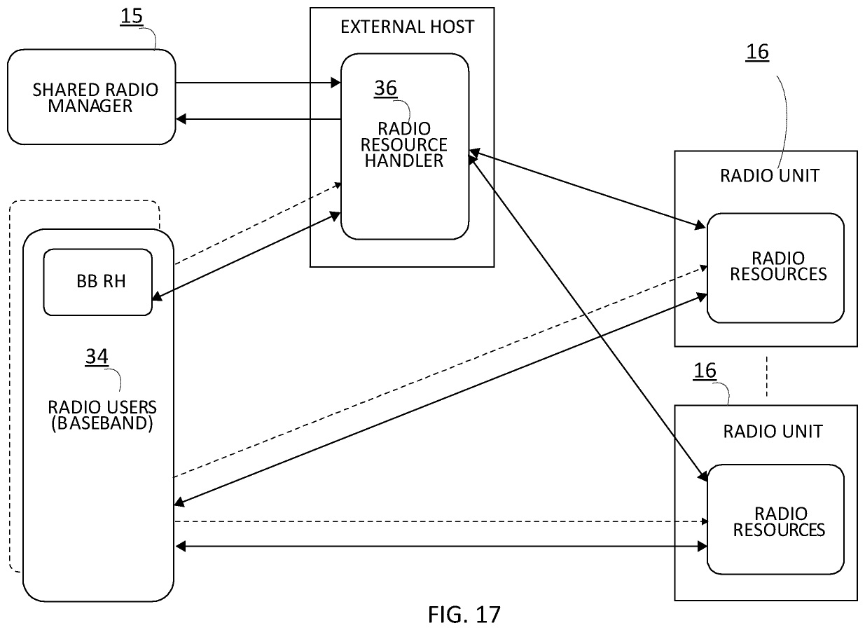

In some embodiments, the RRH 36 may be built into the same physical and/or logical unit as one or more of the radio resources and/or shared radio units (e.g., network nodes 16), as shown in the example configuration of FIG. 16. In some embodiments, the RRH 36 may be centralized, e.g., managing several distributed radio resources, as shown in the example configuration of FIG. 17, in which, for example, the RRH 36 may be physically and/or logically separate from one or more shared radio units (e.g., network nodes 16)/radio resources, and wherein the RRH 36 may be in communication with a shared radio manager 15, which may be a separate device, may be part of core network 14, and/or may be co-located with any of the RRH 36, BB 34, and/or network node 16.

A centralized RRH 36 may also include deployment and/or environment knowledge (e.g., known relations between radio units (network nodes 16) based on installation information from one or more management systems), which may help schedulers to coordinate transmission and/or reception (e.g., to avoid interference between distributed radio units/network nodes 16).

In some embodiments described herein, the dynamic RRH 36 may handle one or more of the following transmission and/or reception resource types (e.g., for one or more radio users/BBs 34):

Statically configured guaranteed resources for each radio user/BB 34, e.g., based on policies (e.g., a BB 34 may pay the network operator for a particular guaranteed set of resources and/or quality of service), static signaling requirements (e.g., necessary control signaling), etc. As used herein, “static” may refer to resources/allocations/requirements/etc. which do not vary over time, which vary relatively slowly over time (e.g., as compared to dynamically configured resources), and/or which are assigned/required/configured indefinitely.

Dynamically configured guaranteed resources for each user, e.g., where allocation may change over time based on, e.g., number of users, their needs, available resources in the radio(s), radio conditions, capabilities, etc. As used herein, “dynamic” may refer to resources/allocations/requirements/etc. which vary over time, which vary relatively more frequently over time (e.g., as compared to statically configured resources), and/or which are assigned/required/configured for a finite/predefined amount of time.

Shared resources, e.g., available for some or all users, where allocation priorities may be applied based on short-term and/or long-term conditions/policies/priorities, including priorities associated with end user services. For example, those BBs 34 which pay a relatively higher rate to the network operator may be assigned a (long-term) higher priority in being assigned shared resources relative to other BBs 34 which pay a lower rate. As another example, those BBs 34 which are in an emergency state, or which are serving end users (e.g., wireless devices 22) in an emergency state, may be assigned a (short-term) higher priority relative to other BBs 34 which are not in an emergency state or which are not serving end users in an emergency state. Available shared resources may also change over time, e.g., based on changes in policies, in the configuration of guaranteed resources, radio conditions, capabilities, etc. A BB 34 may state/indicate one or more resource needs, each resource need representing a relative priority of the end user service associated with the resource need, and the network may consider these stated resources needs in allocating the shared resources among the BBs 34. In one or more embodiments, a separate configuration of user unique (guaranteed) resources and shared (non-guaranteed) resources may be supported. Rules for allocation(s) of resources between radio users/BBs 34 may be based on policies and may be applied either statically and/or vary dynamically over time. Configuration(s) of resources and policies may be applied from external management systems and/or negotiated with the currently attached radio users/BBs 34.

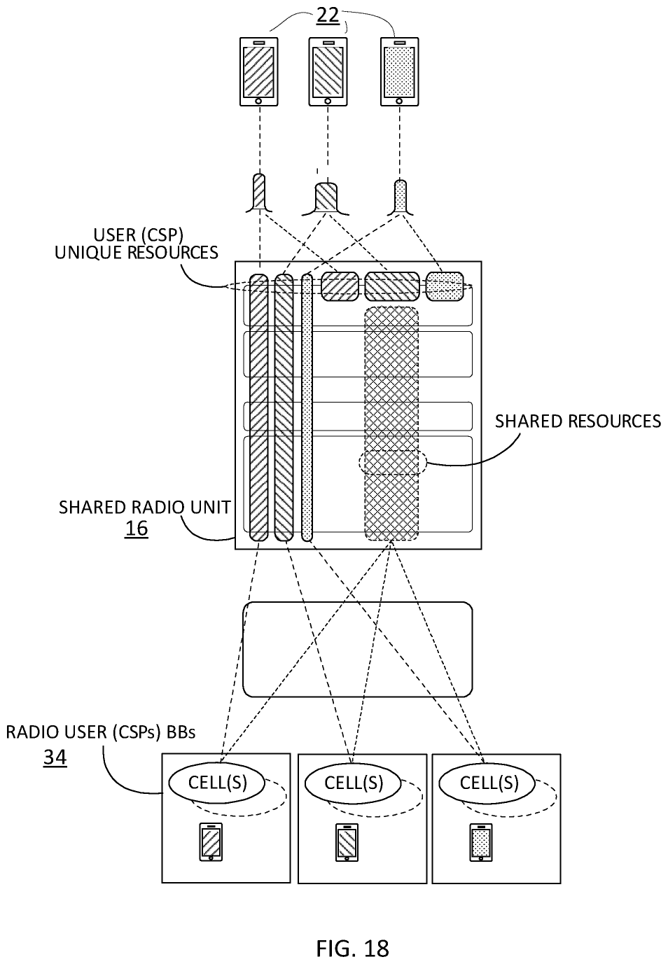

In some embodiments, shared Radio Equipment (e.g., network node 16) may be configured with at least 2 queues per radio user, e.g., one queue for unique guaranteed processing/radio resources and one queue for shared radio/processing resources, as shown in the example scenario of FIG. 18.

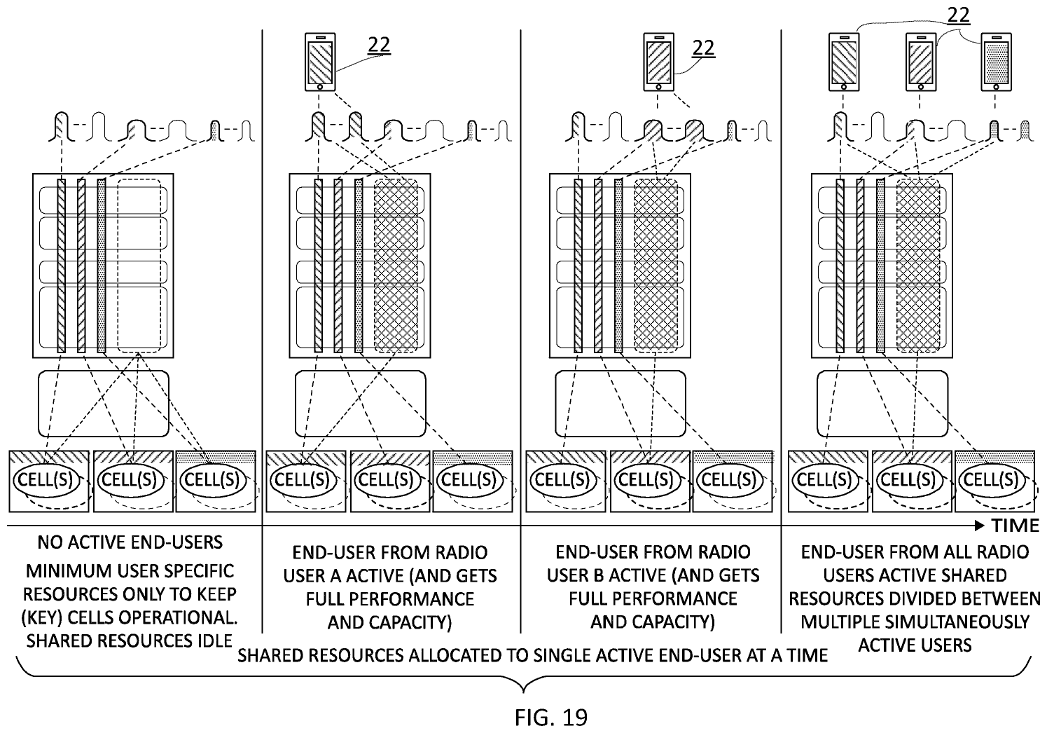

During operation, the RRH 36 may allocate shared resources in accordance with configuration and policies, e.g., to maximize utilization of processing capabilities and/or optimizing system and/or end-user performance, as shown in the example use scenario of FIG. 19.

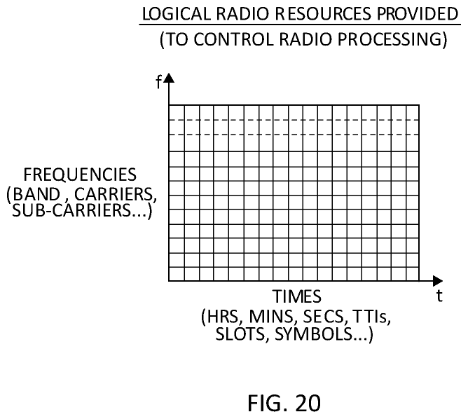

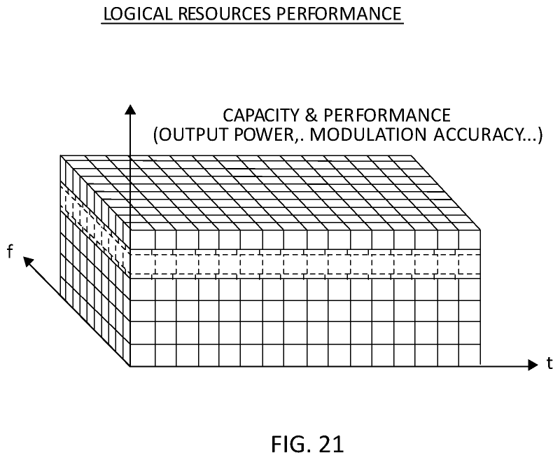

Logical Radio Resources (e.g., provided by an RRH 36 and/or requested from radio users/BBs 34) are divided over time (e.g., TTIs, slots, symbols, etc.) and/or frequency (bands, carriers, sub-carriers), as illustrated in FIG. 20. Each logical frequency/time resource may also have an associated level of performance, as illustrated FIG. 21.

If an overload/congestion scenario occurs (e.g., where a total need for shared resources cannot be satisfied), the RRH 36 may be configured to discard processing (e.g., activities associated with transmission and/or reception) for one or more BBs 34, and/or may perform such processing with reduced performance.

In some embodiments of the present disclosure, smaller, cheaper, and/or more power-efficient radios may be used to offer maximum capacity to all BBs 34 utilizing shared resources (e.g., shared resources of network node 16) without requiring dimensioning for simultaneous maximum use of radio resources.

Some embodiments described herein may enable deployment of similar products for Single and Multiple User (CSP) needs, which may assist with concentrating product volumes on fewer product variants (e.g., offering improved economies of scale).

Some embodiments described herein may enable shared radio units (e.g., network nodes 16) to dynamically adjust resource capability, e.g., to stay within limitations of power supply (e.g., a Shared Radio Manager 15 may inform an RRH 36 of power limits, such as Power over Ethernet (POE) limits).

Some embodiments described herein may enable reduced fronthaul capacity need with shared resource management, as compared with existing solutions.

Some embodiments described herein may enable improved interference and passive intermodulation (PIM) avoidance management, as compared with existing solutions.

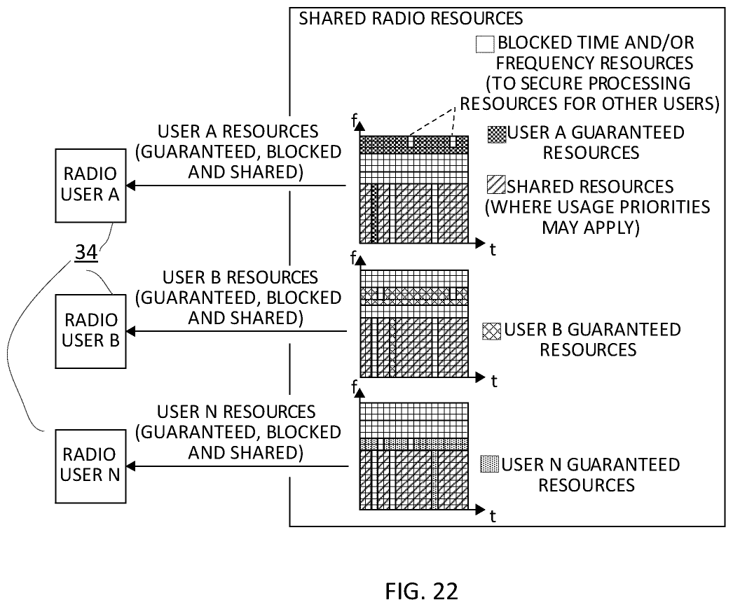

Some embodiments provide a RRH 36 responsible for allocating the resources of each radio it is responsible for, and sending those allocations to the users of each such radio. The RRH 36 may have received information about the capabilities of each radio. The capabilities may be received from a management node (e.g., shared radio manager 15) and/or from the radio (e.g., network node 16) itself. The capabilities may be updated based on, e.g., temperature variations, hardware faults, and/or power saving states. The RRH 36 may be configured with information on desired power save states that the radio may request to enter, e.g., periodic sleep, output-power-steps, etc. For example, FIG. 22 shows an allocation example where RRH 36 controls use of shared radio resources (in one or several shared radio units/network nodes 16) to not overload radios.

In some embodiments, resources may be allocated (e.g., by the RRH 36) based on one or more of:
1. Configuration of RRH 36 from management systems, e.g., static allocations and/or static priority.
2. Resource negotiation between BB 34 schedulers and the RRH 36, e.g., radio users (BBs 34) send a request to the RRH 36 and the RRH 36 sends allocations back to the BBs 34.
3. Internal analysis in the RRH 36 of resource allocation needs based on historic use, e.g., the radio units and/or BBs 34 send the radio users' usage statistics to the RRH 36, which may analyze a time trend, determine new allocations, and send updated allocations to radio users (BBs 34).

One or more of the above three techniques may be combined.

With resource negotiation, the RRH 36 may receive one or more requests from each radio user (BB 34), e.g., indicating and/or predicting the needed resources for a future period of time. The request may be of low resolution, e.g., ‘X resources until further notice’, and/or may be a fine-grained request, e.g., ‘X1 resources the next slot, X2 resources the following slot, X3 . . . ,’ where a slot reflects the air interface structure, and may be a predefined time period, e.g., 500 ms. The fine-grained (e.g., specific) request may allow the radio user (BB 34) to specify when it is more important to have high amount of resources, which may be for one or more reasons, for example: indicting when cell-defining signals are sent, indicting when a transmission spanning multiple radios is preferably sent, indicating if a periodic bearer is used (e.g., cable replacement), etc. The request may further express multiple priorities, e.g., a first (high) priority which is necessary (also known as the unique resources), a second priority, a third priority, etc. For example, the second priority may indicate that a transmission is necessary to fulfill end users' services and/or is important for the network performance, and the third priority may include other data, e.g., data not meeting the first priority or second priority criteria. In some embodiments, the second priority may be restricted from being moved in time, whereas the third priority may have no such restriction.

The RRH 36 may send allocation information to the radio users (BBs 34) based on, e.g., the BB 34 requests, historical information, available resources, priorities, power/energy considerations, etc. For example, in addition to the requests from the BB 34s, the RRH 36 may use information on previous utilization of the given allocations (e.g., to compensate for over-requesting or under-requesting), a current radio state (capabilities), and/or potential radio power-save states. Based on this information, each allocation may be calculated, and each allocation may be expressed, e.g., using a low time resolution allocation, such as allocating Y resources until next allocation information, and/or using a fine-grained allocation, such as allocating Y1 during the next slot, Y2 during the slot after that, Y3 . . . , etc., for a set of slots. The allocation may be iterative, e.g., specifying a pattern of N slots which is then iterated by the radio user. The allocation may contain information about allocation per priority level. The priority levels may include, for example, a ‘unique’ priority level, a ‘guaranteed shared’ priority level, a ‘best effort’ priority level, etc. In some embodiments, the priorities levels may include only two levels, such as a ‘guaranteed’ priority level and a ‘non-guaranteed’ priority level).

In some embodiments, fine-grained allocating may be used to generate one or more time periods where some users (BBs 34) or no users have resources allocated, which may enable the radio unit(s) (e.g., network nodes 16) to enter a sleep mode. The fine grained allocation may enable the RRH 36 to reduce interference in the network, e.g., by time multiplexing transmissions from nearby radio units, allocating disjunct time intervals on the different radio units, e.g., BB 34a gets even slot numbers from a first radio unit (e.g., network node 16a) and odd slot numbers from a second radio unit (e.g., network node 16b). In some embodiments, one or both of the nearby radio units (e.g., network nodes 16) may be used for simultaneous transmission/reception with the same wireless device 22, and the RRH 36 may allocate matching resources on both radio units (network nodes 16) to the same BB 34 and/or wireless device 22.

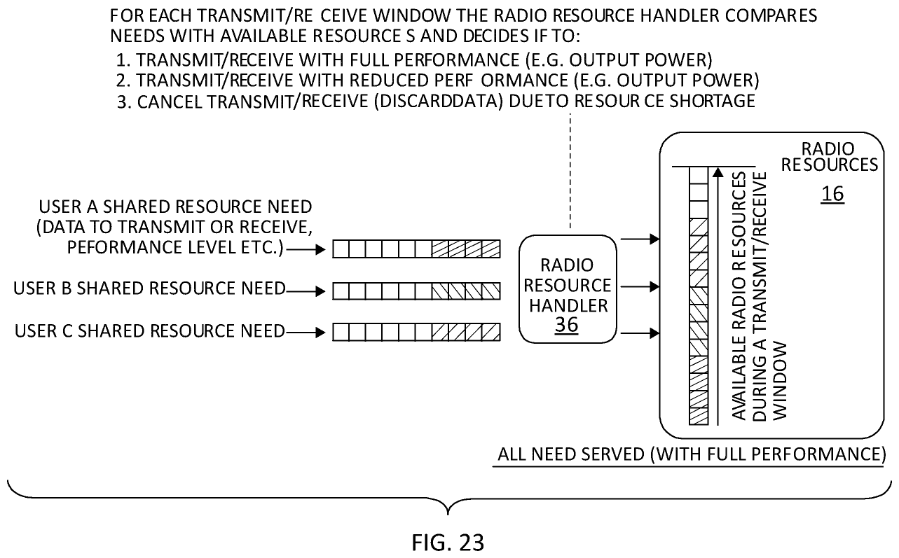

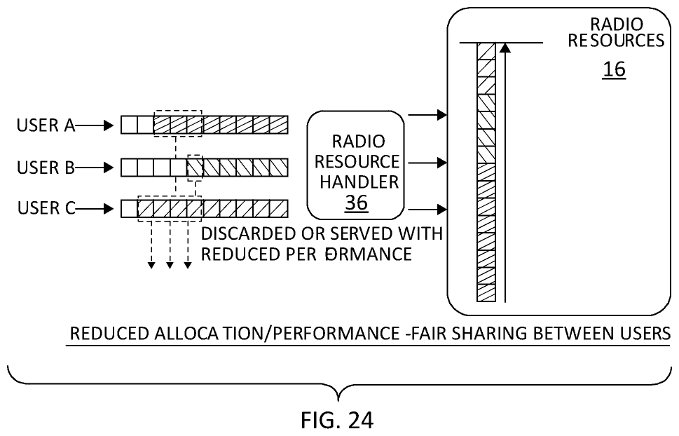

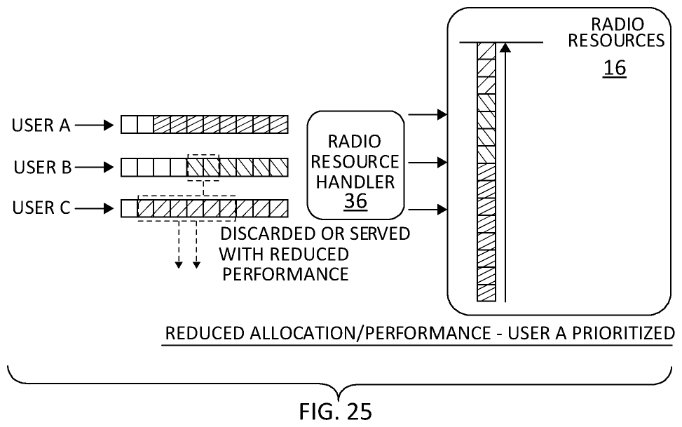

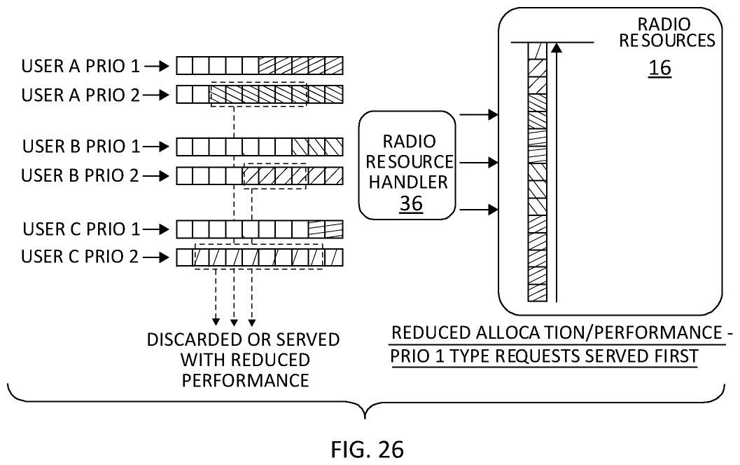

In more embodiments, the RRH 36 may handle resource allocation autonomously, e.g., based on contention(s) between users, and optionally may apply priorities based on pre-configured and/or negotiated policies (e.g., from a management system and/or from BBs 34). A first example resource allocation scenarios as described herein is depicted in FIG. 23. A second example resource allocation scenarios as described herein is depicted in FIG. 24. A third example resource allocation scenarios as described herein is depicted in FIG. 25. A fourth example resource allocation scenarios as described herein is depicted in FIG. 26.

Run-time information about allocations and/or success in using allocated resources may be reported to radio users (BBs 34) or such information may remain within the RRH 36 (e.g., to reduce signaling complexity between the RRH 36 and radio users/BBs 34).

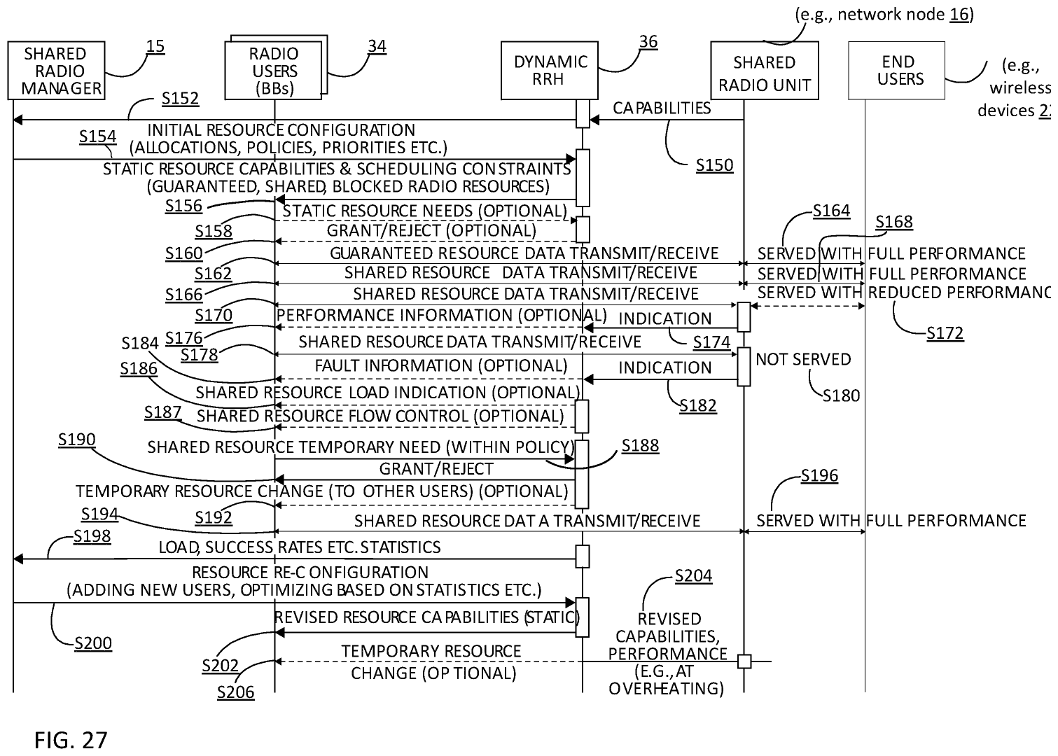

FIG. 27 is an example signaling diagram according to one or more embodiments of the present disclosure. In Step S150, the RRH 36 (i.e., dynamic RRH 36) receives from one or more shared radio units (e.g., network nodes 16) an indication of capabilities (e.g., radio resources). In Step S152, the RRH 36 transmits/forwards the indication of radio resources/capabilities to the shared radio manager 15. In Step S154, the shared radio manager 15 transmits an initial resource configuration, which may include, for example, allocations (e.g., of radio/processing resources), policies, priorities, etc., to the RRH 36. In Step S156, the RRH 36 transmits a static resource capability indication including scheduling constraints, indicating, for example, guaranteed, shared, and/or blocked radio resources, to one or more BBs 34. In Step S158, which may be optional, one or more BBs 34 transmit static resource needs/requirements to the RRH 36. In Step S160, which may also be optional, the RRH 36 responds to the one or more BBs 34 with a resource grant or reject indication. In Step S162, the BBs 34 transmit and/or receive data using the guaranteed resources of a shared radio unit (e.g., network node 16), and the end users (e.g., wireless devices 22 served by network node 16) are served with full performance (Step S164). In Step S166, one or more of the BBs 34 transmit and/or receive data using shared resources of a shared radio unit (e.g., network node 16), and the end users (e.g., wireless devices 22 served by network node 16) are served with full performance (Step S168). In Step S170, one or more of the BBs 34 transmit and/or receive data using shared resources of a shared radio node (e.g., network node 16), and the end users (e.g., wireless devices 22 served by network node 16) are served with reduced performance (Step S172). In Step S174, which may be optional, the shared radio unit (e.g., network node 16) transmits an indication to the RRH 36 which indicates that the end users (wireless devices 22) were served with reduced performance. In Step S176, which may be an optional step, the RRH 36 transmits performance information to one or more of the BBs 34. In Step S178, the BBs 34 attempt to transmit and/or receive data using shared resources of a shared radio node (e.g., network node 16), but the end users (e.g., wireless devices 22 served by network node 16) are not served (Step S180), e.g., due to a fault. In Step S182, the shared radio unit (e.g., network node 16) transmits an indication to the RRH 36 which indicates that the end users (wireless devices 22) were not served. In Step S184, which may be an optional step, the RRH 36 transmits fault information to one or more of the BBs 34. In Step S186, which may be an optional step, the RRH 36 transmits a shared resource load indication to one or more of the BBs 34. In Step S187, which may be an optional step, the RRH 36 transmits a shared resource flow control indication to one or more of the BBs 34.

In Step S188, one or more of the BBs 34 transmits a shared resource temporary need to the RRH 36, which may be based on a policy associated with one or more BBs 34. In Step S190, the RRH 36 responds to the one or more BBs 34 with a resource grant or reject indication. In Step S192, which may be an optional step, the RRH 36 transmits a temporary resource change to other BBs 34. In Step S194, one or more of the BBs 34 transmit/receive data using shared resources, and the end users (e.g., wireless devices 22 served by network node 16) are served with full performance (Step S196). In Step S198, the RRH 36 transmits an indication of load, success rates, usage/performance statistics, etc. to the shared radio manager 15. In Step S200, the shared radio manager 15 responds to the RRH 36 with a resource re-configuration indication, for example, adding new users, optimizing based on the reported statistics, etc. In Step S202, the RRH 36 transmits a revised resource capabilities indication (e.g., a revised static configuration) to one or more of the BBs 34. In Step S204, the shared radio node (e.g., network node 16) transmits an indication of revised capabilities, performance, conditions (e.g., overheating), etc. to the RRH 36. In Step S206, which may be an optional step, the RRH 36 transmits an indication of a temporary resource change to one or more of the BBs 34.

It is to be understood that the steps described in FIG. 27 may be performed in a different order, and/or one or more of the steps may be optional. Further, one or more of the steps described in FIG. 27 may be realized as multiple sub-steps, for example, a signal described as transmitted in a single step may be realized as multiple signals/steps, each containing portions of the associated information. For example, some information may be sent at one phase/step/signal, and the information may be further modified/supplemented via additional subsequent phases/steps/signaling. As another example, one or more of the steps described in FIG. 27 may be substituted, for example, for a step requiring the transmission of a message containing information from a first entity to a second entity, the second entity may be instead pre-configured to store the information., the second entity may receive the information from a third entity, etc.

In one or more embodiments of the present disclosure, BB 34 may request (e.g., from RRH 36) traffic/performance resources (e.g., a requested data transfer speed, a requested latency, a requested quality of service, etc.), and/or may explicitly request particular resources (e.g., a power level, an antenna, a bandwidth, a set of frequency-domain resources, a set of time-domain resources, a signal processing resource, etc.).

The terms “resource for transmission” and “transmission resource” as used herein includes a shared radio unit (e.g., network node 16) transmitting to a wireless device 22 using the resource and/or a wireless device 22 transmitting to a shared radio unit (network node 16) using the resource.

In one or more embodiments of the present disclosure, the BB 34 and/or the shared radio unit (network node 16) sends one or more indications of usage statistics to the RRH 36. The RRH 36 may collect such statistics over time, which may include, for example, historical resource usage of one or more BBs 34, observed performance/speed/throughput/latency, interference, faults, dropped transmissions, etc. The RRH 36 may use this historical information to modify the static and/or dynamic resource allocations among the BBs 34.

In one or more embodiments of the present disclosure, the shared radio unit (e.g., network node 16) capabilities and/or state may change (e.g., based on environmental conditions, interference, hardware changes, etc.), and the RRH 36 and/or BBs 34 may receive an indication indicating/associated with/based on the change of state/capabilities.

An advantage of one or more embodiments of the present disclosure is that a network operator may be able to install radio units (e.g., network nodes 16) with a reasonably limited capacity, rather than installing radio units which are dimensioned for simultaneous peak usage for all clients (e.g., BB 34 instances), even where every client (e.g., BB 34 instance) is acting independently of one another. One objective of the present disclosure is therefore to subdivide the limited resources of the shared radio unit (e.g., network node 16) to the clients (BB 34 instances), such that policies are enforced, including priority, fairness, quotas, etc., and at the same time maximizing the value of the radio (e.g., usage percentage, air interface utilization, air interface efficiency, etc.). An amount of resources available in the shared radio unit (e.g., network node 16) may vary slowly, for example, due to temperature (the radio may overheat if constantly used at full power). The resources allocated to a particular BB 34 may vary, e.g., based on a pending traffic quantity, a quality of service class, a radio link quality to a served user (e.g., wireless device 22), a type of radio transmission to a wireless device 22 (e.g., whether multi-radio or not), etc.

In one or more embodiments, a BB 34 is configured to operate in a default mode in which it sends requests for allocations to the RRH 36 which responds with an allocation which applies for a finite duration of time. Alternatively, the RRH 36 may base allocations primarily on usage statistics received from the shared radio unit (e.g., network node 16). Such allocations may be slow to react to a changing need when compared to other allocations but may also require less signaling. As another alternative, the RRH 36 may over-allocate the radio resources (e.g., “overbooking”). In other words, more resource allocations are handed out than resources are available in a shared radio unit (network node 16). The shared radio unit (network node 16) may discard/drop parts of the traffic sent from the BB 34, if needed. This may result in higher utilization of the radio resources and may also partially mitigate the slowness of relying on usage statistics. If the over-allocation is optimistic and many discards/drops occur, this technique may require that the shared radio unit (network node 16) sends information back to the BB 34 indicating the discarded/dropped traffic.

In one or more embodiments, the RRH 36 may receive information from a distributed unit (DU) and/or from a radio hardware unit (RU) of shared radio unit (network node 16), regarding usage, capabilities, needs, etc. The RRH 36 may be configured to subdivide resources between DU clients, and to send allocations to one or more DU clients. The RRH 36 may be configured to implement different types of algorithms for subdividing the resources, for example, based on usage statistics, configured policies, DU reported needs, RU reported capabilities, etc. The RRH 36 may be configured to subdivide resources in the time-domain and/or the frequency domain, and may be configured for optional overbooking. The RRH 36 may optionally subdivide the resources of multiple shared radio units (network nodes 16) using the same algorithm, which may improve RAN performance.

In one or more embodiments, the BB 34 may indicate its future requirements to the RRH 36, which may be based on a combination of estimated/predicated traffic requirements and/or known air interface control signals. The BB 34 may be configured to interpret responses from the RRH 36, and to prioritize its traffic according to rules received from the RRH 36. The BB 34 may be configured to optionally interpret information about discarded/dropped traffic.

In one or more embodiments, the shared radio unit (network node 16) may be configured to indicate its capabilities to the RRH 36. The shared radio unit (network node 16) may be configured to optionally receive information regarding resource labeling from the shared radio manager 15 and/or RRH 36 (e.g., to enumerate resources and/or aid in enforcement of policies). The shared radio unit (network node 16) may be configured to optionally enforce the capability restrictions on incoming requests, such as in overbooking scenarios. The shared radio unit (network node 16) may be configured to optionally send usage statistics to the RRH 36.

In some embodiments, the RRH 36 may be implemented as a standalone device. In other embodiments, the RRH 36 may be physically and/or logically integrated with either a BB 34 and/or a shared radio unit (network node 16).

In some embodiments, the resource allocations express what resources the client (e.g., BB 34) may use and what the client (BB 34) may expect of the shared radio unit (network node 16). The allocation may contain different sub-allocations, where each sub-allocation may have its own properties. A sub-allocation may include guarantees, such as a guaranteed transmission/best effort transmission; full performance/pooled performance/best effort performance, e.g., if the client (BB 34) can use a certain output power for the allocation or if the power is shared with other clients (other BBs 34); and time intervals/frequency blocks, which may include, for example, a frequency range and “until further notice” indication, strict time intervals (e.g., certain OFDM symbols), strict frequency blocks for each such time interval, etc., to follow the air interface frame structure.

In some embodiments, requests may include one or more requested values and/or one or more sub-requests, e.g., reflecting a quality of service of the BB 34 users to serve and/or the importance of the transmission (e.g., cell control signals being of a higher importance than user data).

In one or more embodiments, a BB 34 sends requests at any suitable interval, and/or sends requests based on events in the system (e.g., traffic, configuration, or response to allocation from the RRH 36). Each BB 34 client may only be configured to understand its own RAT. The RRH 36 may send allocations at any suitable interval, and/or based on events in the system (e.g., new decisions due to requests or capability changes, configuration, etc.). The RRH 36 may be configured to understand multiple RATs and may be configured to express allocations according to the respective RAT of a particular client (BB 34). The shared radio unit (network node 16) may be configured to send capability changes to the RRH 36. Optionally, the RRH 36 may be configured to send a configuration to the shared radio unit (network node 16) for aiding the shared radio unit (network node 16) in configuring local enforcement functions.

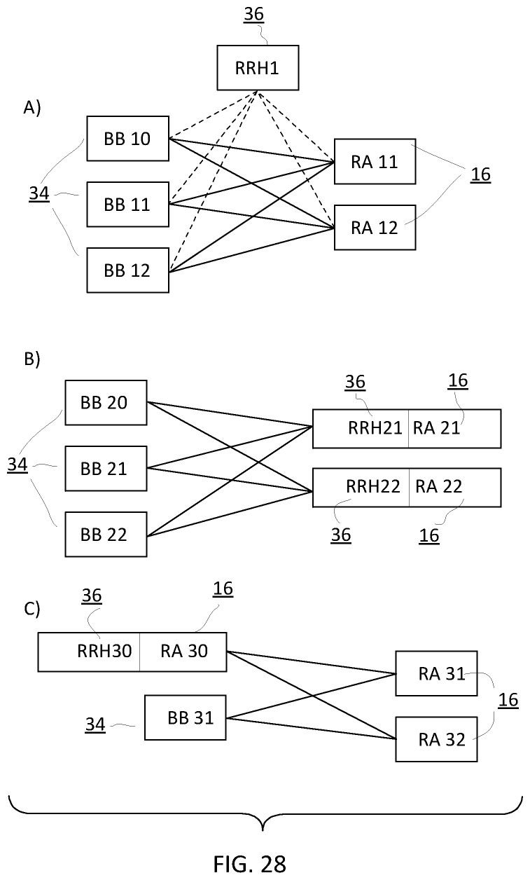

FIGS. 28A-C depict three example configurations according to one or more embodiments of the present disclosure. In particular, FIG. 28A depicts an example configuration in which a RRH 36 (“RRH1”) is in communication with three BBs 34 (“BB 10”, “BB 11”, and “BB 12”), and with two shared radio units (network nodes 16) (“RA 11” and “RA 12”). Each of the BBs 34 is in communication with each of the two shared radio units (network nodes 16). FIG. 28B depicts another example configuration in which there are two RRHs 36 (“RRH21” and “RRH22”), each of which is co-located with a respective shared radio unit (network node 16) (“RA 21” and “RA 22”, respectively). Each of the BBs 34 (“BB 20”, “BB 21”, and “BB 22”) is in communication with each of the co-located RRH 36s and shared radio units (network nodes 16). FIG. 28C depicts another example configuration in which there are two BBs 34 (“BB 30” and “BB 31”), two shared radio units (network nodes 16) (“RA 31” and “RA 32”), and one RRH 36 (“RRH30”) which is co-located with one of the BBs 34 (“BB 30”), and each of the BBs 34 is in communication with each of the shared radio units (network nodes 16).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A radio resource handler, RRH, configured to communicate at least with a plurality of baseband units and a first shared radio unit that is shared by the plurality of baseband units, the RRH comprising processing circuitry configured to:
receive a first resource indication associated with the first shared radio unit, the first resource indication indicating a plurality of dedicated resources and a plurality of shared resources;
determine a first resource grant based at least on the first resource indication, the first resource grant indicating at least one of:
at least a first resource from the plurality of dedicated resources to allocate to a first baseband unit of the plurality of baseband units; and
at least a second resource from the plurality of shared resources to allocate to the first baseband unit; and
cause transmission of the first resource grant to the first baseband unit.

2. The RRH of claim 1, wherein the processing circuitry is further configured to:
receive a first status indication associated with the first shared radio unit, the determining of the first resource grant being further based on the received first status indication.

3.-22. (canceled)

23. A method implemented in a radio resource handler, RRH, configured to communicate at least with a plurality of baseband units and a first shared radio unit that is shared by the plurality of baseband units, the method comprising:
receiving a first resource indication associated with the first shared radio unit, the first resource indication indicating a plurality of dedicated resources and a plurality of shared resources;
determining a first resource grant based at least on the first resource indication, the first resource grant indicating at least one of:
at least a first resource from the plurality of dedicated resources to allocate to a first baseband unit of the plurality of baseband units; and
at least a second resource from the plurality of shared resources to allocate to the first baseband unit; and
causing transmission of the first resource grant to the first baseband unit.

24. The method of claim 23, further comprising:
receiving a first status indication associated with the first shared radio unit, the determining of the first resource grant being further based on the received first status indication.

25. The method of claim 24, wherein the first status indication indicates at least one of:
a hardware capability of the first shared radio unit;
a temperature state of the first shared radio unit; and
an interference state of the first shared radio unit.

26. The method of claim 25, further comprising receiving a second status indication associated with the first shared radio unit, the receiving of the second status indication being subsequent to the receiving of the first status indication, the second status indication being associated with a change in at least one of:
the hardware capability of the first shared radio unit;
the temperature state of the first shared radio unit; and
the interference state of the first shared radio unit.

27. The method of claim 26, further comprising receiving a third status indication from the first baseband unit, the third status indication being associated with an interference state of the first shared radio unit, the determining the first resource grant being further based on the third status indication.

28. The method of claim 23, further comprising:
receiving a first resource request from the first baseband unit, the determining of the first resource grant being further based on the received first resource request.

29. The method of claim 28, further comprising:
receiving a second resource request from a second baseband unit of the plurality of baseband units, the determining of the first resource grant being further based on the second resource request.

30. The method of claim 28, wherein the first resource request includes at least one of:
an amount of data to be transmitted,
a quality of service class indication,
a radio link quality indication,
a user priority indication,
a power level indication,
an antenna indication,
a time-domain resource indication, and
a frequency-domain resource indication.

31. The method of claim 28, wherein the first resource request indicates at least one of:
a current traffic requirement associated with a plurality of wireless devices in communication with the first shared radio unit,
a predicted traffic requirement associated with a plurality of wireless devices in communication with the first shared radio unit, and
a fixed resource requirement associated with a plurality of wireless devices in communication with the first shared radio unit.

32. The method of claim 23, wherein each of the plurality of dedicated resources is associated with a corresponding one of the plurality of baseband units.

33. The method of claim 23, wherein the determining the first resource grant is further based on historical usage data associated with at least one of the plurality of baseband units.

34. The method of claim 23, wherein the first resource grant indicates at least one of:
a frequency range for transmission,
a time interval for transmission, and
an until further notice indication.

35.-44. (canceled)

45. A shared radio unit configured to communicate at least with a radio resource handler, RRH, a plurality of baseband units, and a plurality of wireless devices, the shared radio unit being shared by the plurality of baseband units, the shared radio unit comprising processing circuitry configured to:
receive a resource selection associated with a first baseband unit of the plurality of baseband units, the resource selection indicating at least one of:
at least one first resource from a plurality of dedicated resources, the at least one first resource being allocated to the first baseband unit; and
at least one second resource from a plurality of shared resources, the at least one second resource being allocated to the first baseband unit; and
determine, based on the resource selection, at least one resource for transmission.

46. The shared radio unit of claim 45, wherein the processing circuitry is further configured to:
at least one of:
cause transmission of data to at least one wireless device using the determined at least one resource for transmission; and
receive data from at least one wireless device using the determined at least one resource for transmission.

47.-51. (canceled)

52. A method implemented in a shared radio unit configured to communicate at least with a radio resource handler, RRH, a plurality of baseband units, and a plurality of wireless devices, the shared radio unit being shared by the plurality of baseband units, the method comprising:
receiving a resource selection associated with a first baseband unit of the plurality of baseband units, the resource selection indicating at least one of:
at least one first resource from a plurality of dedicated resources, the at least one first resource being allocated to the first baseband unit; and
at least one second resource from a plurality of shared resources, the at least one second resource being allocated to the first baseband unit; and
determining, based on the resource selection, at least one resource for transmission.

53. The method of claim 52, further comprising:
at least one of:
causing transmission of data to at least one wireless device using the determined at least one resource for transmission; and
receiving data from at least one wireless device using the determined at least one resource for transmission.

54.-58. (canceled)

59. A baseband unit in communication with at least a radio resource handler, RRH, and a shared radio unit, the baseband unit being associated with a plurality of wireless devices, the baseband unit comprising processing circuitry configured to:
receive, from the RRH, a resource grant indicating at least one of:
at least one first resource from a plurality of dedicated resources, the at least one first resource being allocated to the baseband unit; and
at least one second resource from a plurality of shared resources, the at least one second resource being allocated to the baseband unit;
determine, based on the resource grant, at least one resource for transmission; and
causing transmission of a resource selection to the shared radio unit indicating the at least one determined resource for transmission.

60. The baseband unit of claim 59, wherein the processing circuitry is further configured to:
transmit a resource request to the RRH, the resource request being associated with the shared radio unit, the received resource grant being based on the transmitted resource request.

61.-78. (canceled)
